(19) United States
(12) Patent Application Publication
(10) Pub. No.: US 2022/0297233 A1
(43) Pub. Date: Sep. 22, 2022

(54) VARIABLE BEAM GEOMETRY ENERGY BEAM-BASED POWDER BED FUSION

(71) Applicant: DIVERGENT TECHNOLOGIES, INC., Los Angeles, CA (US)

(72) Inventors: Chor Yen YAP, Gardena, CA (US); Michael Thomas Kenworthy, Rancho Palos Verdes, CA (US)

(21) Appl. No.: 17/697,829

(22) Filed: Mar. 17, 2022

Related U.S. Application Data
(60) Provisional application No. 63/162,919, filed on Mar. 18, 2021.

(51) Int. Cl. B23K 26/06; B22F 12/41; B22F 10/28; B22F 10/36; B33Y 30/00; B33Y 50/02; B23K 26/342; G02B 27/09

(52) U.S. Cl. CPC B23K 26/0648; B22F 12/41; B22F 10/28; B22F 10/36; B33Y 30/00; B33Y 50/02; B23K 26/0665; B23K 26/342; G02B 27/09

(57) ABSTRACT

Apparatuses for additive manufacturing producing an annular beam are disclosed herein. An apparatus in accordance with an aspect of the present disclosure comprises an energy beam source configured to generate an energy beam and a beam shaping applicator configured to shape the energy beam into a geometry and apply the shaped energy beam to an additive manufacturing material, wherein the geometry includes a two-dimensional shape with a perimeter and a hole in the two-dimensional shape within the perimeter.

### CROSS-REFERENCE TO RELATED APPLICATIONS

The present disclosure claims the benefit under 35 U.S.C. 119 of U.S. Provisional Patent Application No. 63/162,919, filed Mar. 18, 2021 and entitled “VARIABLE BEAM GEOMETRY ENERGY BEAM-BASED POWER BED FUSION”, which application is incorporated by reference herein in its entirety.

### BACKGROUND

### Field

The present disclosure relates generally to additive manufacturing, and more particularly, to variable beam geometry energy beam-based powder bed fusion.

### Background

Powder-bed fusion (PBF) systems can produce metal structures (referred to as build pieces) with geometrically complex shapes, including some shapes that are difficult or impossible to create with conventional manufacturing processes. PBF systems include additive manufacturing (AM) techniques to create build pieces layer-by layer. Each layer or slice can be formed by a process of depositing a layer of metal powder and then fusing (e.g., melting and cooling) areas of the metal powder layer that coincide with the cross-section of the build piece in the layer. The process may be repeated to form the next slice of the build piece, and so on until the build piece is complete. Because each layer is deposited on top of the previous layer, PBF may be likened to forming a structure slice-by-slice from the ground up.

Laser PBF (L-PBF) may be useful for manufacturing complex geometries and with reduced cost of customization. Unfortunately, manufacturing using L-PBF systems can be a slow process compared to what may be needed for high-capacity production. Application of high-power laser systems in current PBF systems may lead to vaporization of materials during the printing process, thereby increasing manufacturing costs.

### SUMMARY

Several aspects of powder bed fusion are described herein. For example, Illustratively, an alloy may include a composition containing a plurality of materials (e.g., elements, metals, etc.).

An apparatus for additive manufacturing in accordance with an aspect of the present disclosure comprises an energy beam source configured to generate an energy beam and a beam shaping applicator configured to shape the energy beam into a geometry and apply the shaped energy beam to an additive manufacturing material, wherein the geometry includes a two-dimensional shape with a perimeter and a hole in the two-dimensional shape within the perimeter.

Such an apparatus further optionally includes the energy beam being a laser beam, the additive manufacturing material including a powder material, and a powder bed fusion chamber.

Such an apparatus further optionally includes a shape of the hole being a circle, an ellipse, or an oval, the two-dimensional shape being a circle, an ellipse, or an oval, and the beam shaping applicator including a deflector configured to control a direction at which the shaped energy beam is applied to the additive manufacturing material. The shape of the geometry may be different than the shape of the hole.

The additive manufacturing material may be arranged in an additive manufacturing environment, and the beam shaping applicator may be configured to shape the energy beam into the geometry based on information relating to the additive manufacturing environment.

The information relating to the additive manufacturing environment may include a focal location of the shaped energy beam within the additive manufacturing environment, a distance from the focal location to a second location, and an angle between the focal location and the second location, the second location being a location corresponding to where the shaped energy beam originates, the second location corresponding to where a focusing lens of the beam shaping applicator is located, or the second location corresponding to where the shaped beam enters the additive manufacturing environment.

The apparatus may further optionally include a controller configured to determine, based on the information relating to the additive manufacturing environment, a distortion, and to control the beam shaping applicator to shape the energy beam into the geometry to compensate for the distortion.

The apparatus may further optionally include the controller being configured to control the beam shaping applicator to shape the energy beam into the geometry to compensate for the distortion by being configured to shape the energy beam into the geometry to compensate for the distortion such that the energy beam has the geometry at a focal location within the additive manufacturing environment.

The apparatus may further optionally include a controller configured to control a power density of the energy beam emitted from the energy beam source.

The apparatus may further optionally include the beam shaping applicator comprising a fixed optical element and a movable optical element aligned to encompass the energy beam, at least one of the optical elements comprising a lens, the beam shaping applicator comprising a first axicon lens, a second axicon lens, and a focusing lens, the beam shaping applicator further comprising a polarizing beam splitter and a detector, and the beam shaping applicator further comprising at least a beam expander, a diffractive beam splitter, a diffractive diffuser, a distortion compensator, an F-theta lens, a phase plate, or a mirror.

It will be understood that other aspects of the present disclosure will become readily apparent to those of ordinary skill in the art from the following detailed description, wherein it is shown and described only several embodiments by way of illustration. As will be realized by those of ordinary skill in the art, the apparatuses, structures, and methods for manufacturing these structures are capable of other and different embodiments, and its several details are capable of modification in various other respects, all without departing from the disclosure. Accordingly, the drawings and detailed description are to be regarded as illustrative in nature and not as restrictive.

### BRIEF DESCRIPTION OF THE DRAWINGS

Various aspects of the present disclosure are presented in the detailed description by way of example, and not by way of limitation, in the accompanying drawings, wherein:

FIGS. 1A-1D illustrate respective side views of a 3-D printer system in accordance with an aspect of the present disclosure.

FIG. 1E illustrates a functional block diagram of a 3-D printer system in accordance with an aspect of the present disclosure.

FIG. 1F illustrates a side view of a 3-D printer system in accordance with an aspect of the present disclosure.

FIG. 2A-2C illustrate a printing process in accordance with an aspect of the present disclosure.

FIG. 3A illustrates a cross-sectional view of an additively-manufactured microtube in accordance with an aspect of the present disclosure.

FIG. 3B illustrates a cross-sectional view of an additively-manufactured microtube in accordance with the related art.

FIG. 4A illustrates a straight-tube microtube heat exchanger in accordance with an aspect of the present disclosure.

FIG. 4B illustrates a curved-tube microtube heat exchanger in accordance with an aspect of the present disclosure.

FIG. 5 illustrates a geometrical change in beam pattern in accordance with an aspect of the present disclosure.

FIGS. 6A and 6B illustrate beam shaping applicators in accordance with an aspect of the present disclosure.

FIGS. 7A-7C illustrate beam shaping applicators in various aspects of the present disclosure.

FIG. 8 is a diagram illustrating an exemplary L-PBF system for scanning a build piece in accordance with an aspect of the present disclosure.

FIGS. 9A-9C illustrate an additively-manufactured geometry in accordance with an aspect of the present disclosure.

FIGS. 10A-10C illustrate cross-sectional views of geometries in accordance with an aspect of the present disclosure.

### DETAILED DESCRIPTION

The detailed description set forth below in connection with the appended drawings is intended to provide a description of various exemplary embodiments of the concepts disclosed herein and is not intended to represent the only embodiments in which the disclosure may be practiced. The term “exemplary” used in this disclosure means “serving as an example, instance, or illustration,” and should not necessarily be construed as preferred or advantageous over other embodiments presented in this disclosure. The detailed description includes specific details for the purpose of providing a thorough and complete disclosure that fully conveys the scope of the concepts to those skilled in the art. However, the disclosure may be practiced without these specific details. In some instances, well-known structures and components may be shown in block diagram form, or omitted entirely, in order to avoid obscuring the various concepts presented throughout this disclosure.

One or more techniques described herein may reduce development costs; reduce processing resources consumption (e.g., by expediting an additive manufacturing process, thus using less processing resources); enable the generation of more accurate additively manufactured components, parts, or systems; enable the generation of microtubes with a diameter less than or equal to 0.X millimeters in diameter (where X equals an integer of 2 or more); enable the generation of microtubes with better circularity; or any combination thereof.

While this disclosure is generally directed to L-PBF systems, it will be appreciated that the techniques disclosed herein can be applied in various AM techniques, such as selective laser sintering (SLS), direct metal laser sintering (DMLS), direct metal laser melting (DMLM), selective laser melting, stereolithography (SLA) 3-D printing, etc. Still other AM processes to which the principles of this disclosure are pertinent include those that are currently contemplated or under commercial development. As used herein, the term “energy beam” may include any form of energy beam that can be shaped by one or more lenses in accordance with principles disclosed herein. For an example, an energy beam may be a laser beam, where the energy is light. As another example, an energy beam may be in the form of heat, radiation, light, or any combination thereof. While the specific details of each such process are omitted to avoid unduly obscuring key concepts of the disclosure, it will be appreciated that the claims are intended to encompass such techniques and related structures.

L-PBF systems can produce metal and polymer structures (referred to as build pieces) with geometrically complex shapes, including some shapes that are difficult or impossible to create using conventional manufacturing processes. L-PBF systems create build pieces layer-by-layer, i.e., slice-by-slice. Each slice may be formed by a process of depositing a layer of metal powder and fusing (e.g., melting and cooling) areas of the metal powder layer that coincide with the cross-section of the build piece in the slice. The process may be repeated to form the next slice of the build piece, and so on, until all the layers are deposited and the build piece is complete.

Aspects of the present disclosure are directed to energy beam spot geometries, such as for L-PBF systems, which may, among other benefits disclosed herein, increase build rate and provide additional control and flexibility of the manufacturing process. An energy beam spot is the area of a surface to which the energy beam is applied. For example, where the energy beam is a laser, the laser spot is the area of a surface illuminated by the laser. Rather than use an energy beam configured as terminating in a tiny, almost point-like spot with a small radius that remains constant over time, an energy beam may instead be configured to use variable beam or spot geometries. In some examples, the beam geometry may refer to the shape of the energy beam as it is applied to the surface of the additive manufacturing material (which may also be referred to as print material). In other examples, the beam geometry may refer to the shape of the energy beam as it enters the additive manufacturing environment (e.g., the shape of the energy beam as it enters the PBF chamber through a beam entry window). The additive manufacturing environment may be, for example, the PBF chamber. In other examples, the beam geometry may refer to the shape of the energy as it leaves the beam shaping applicator, e.g., a beam cross-section. In some examples, the beam geometry may be a line, a square, a rectangle, a triangle, an asymmetrical shape, a curved line, a two-dimensional shape with a curved perimeter, or any other two-dimensional shape. In some examples, the two-dimensional shape with a perimeter may include a non-energy area within the perimeter. The non-energy area may define a hole, i.e., a void space, where the energy beam does not exist. In some examples, the two-dimensional shape with a perimeter may be a circle, ellipse, or oval. In such examples, the non-energy area may be defined as a hole.

An energy beam geometry may be applied to the surface of the print material using two-dimensional scanning. In so doing, the laser beam may be applied in a PBF print operation such that a larger contiguous area of the powder-bed may be processed at any given time. In an embodiment, the beam geometry can be dynamically altered during a 3-D print operation. Thus, for example, the L-PBF 3-D printer may fuse larger areas using a correspondingly large beam geometry, and subsequently or periodically, the 3-D printer may alter the beam geometry to a small line, an ordinary point-like shape, or a 2-D dimensional shape to fuse one or more layers or slices of the build piece in accordance with the beam geometry.

In accordance with aspects of the present disclosure, the energy beam geometry may be adapted based on the geometry of the object (build piece) to be produced. The laser beam geometry may be adapted at the beginning of a scan, on a slice-by slice basis, at a designated time within a slice, or dynamically on the fly (e.g., in real-time based on one or more inputs). Further, the energy beam geometry may also be varied continuously as the beam scans across the powder-bed, whose variance is in accordance with the contemplated structure of the object as identified in a computer aided design (CAD) profile, for example.

Employing the variable beam geometry may beneficially increase the throughput of the L-PBF process. Additionally, adapting the beam geometry as described herein may allow for application of energy beam power over a larger area to the powder bed, meaning that energy flux can be kept small to reduce vaporization of materials. Furthermore, given the two-dimensional nature of the adapted energy beam spot geometry, the energy profile of the spot geometry may be adjusted according to the scan vector (direction of scanning), to provide heating and cooling rate control, distortion control, or a combination thereof. Controlling the cooling rate during the solidification process may allow reduction of thermal stresses and alterations of microstructure in the resultant component to achieve desired material properties. Controlling the distortion of the beam geometry may increase the accuracy of the object being produced.

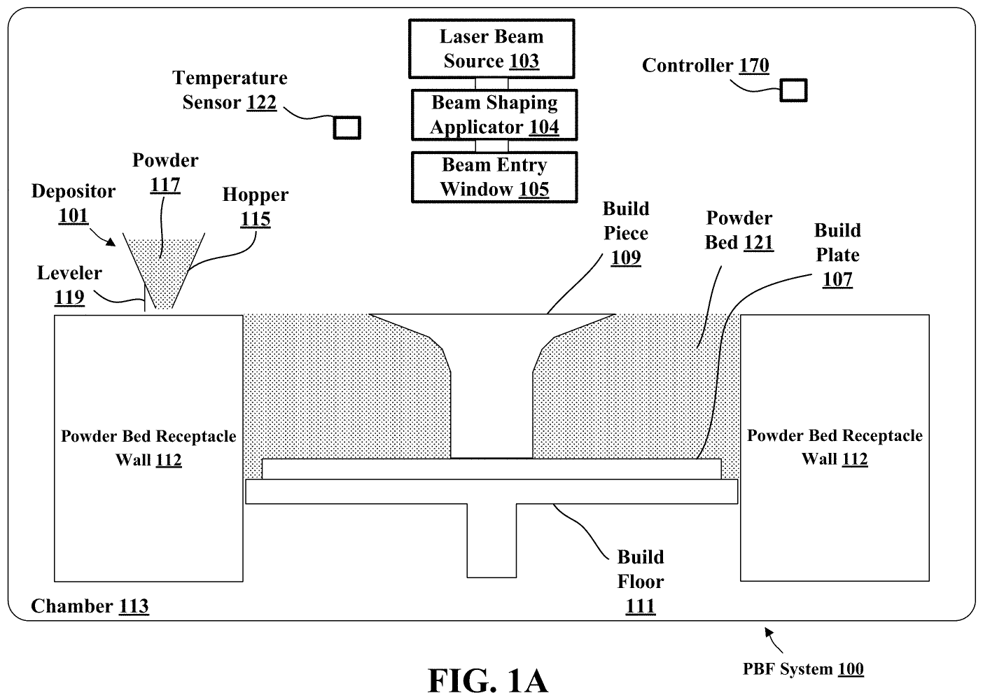

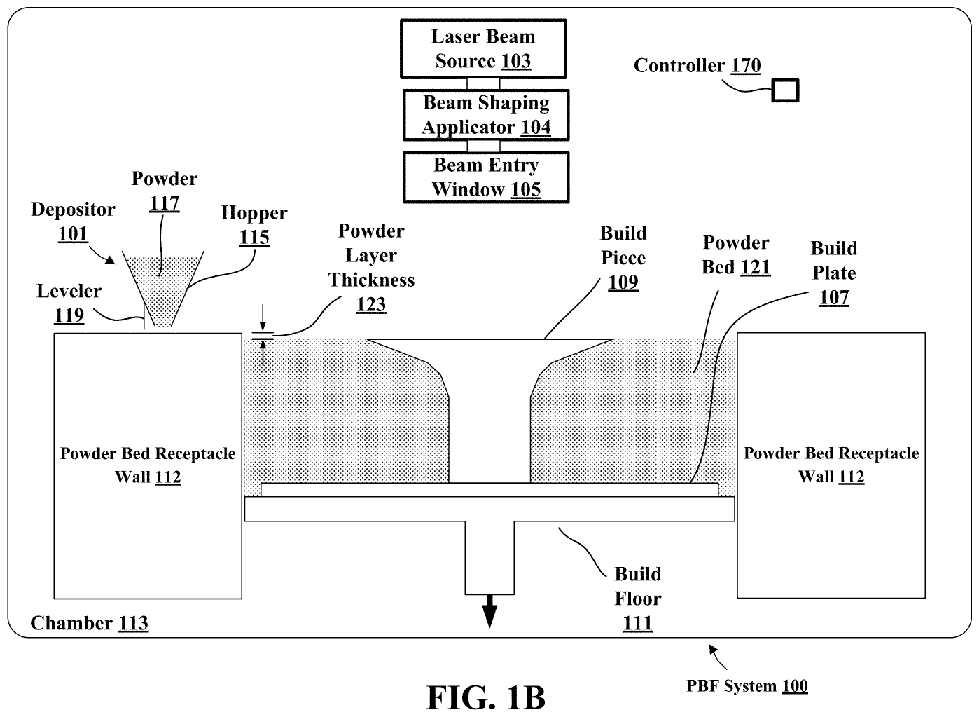

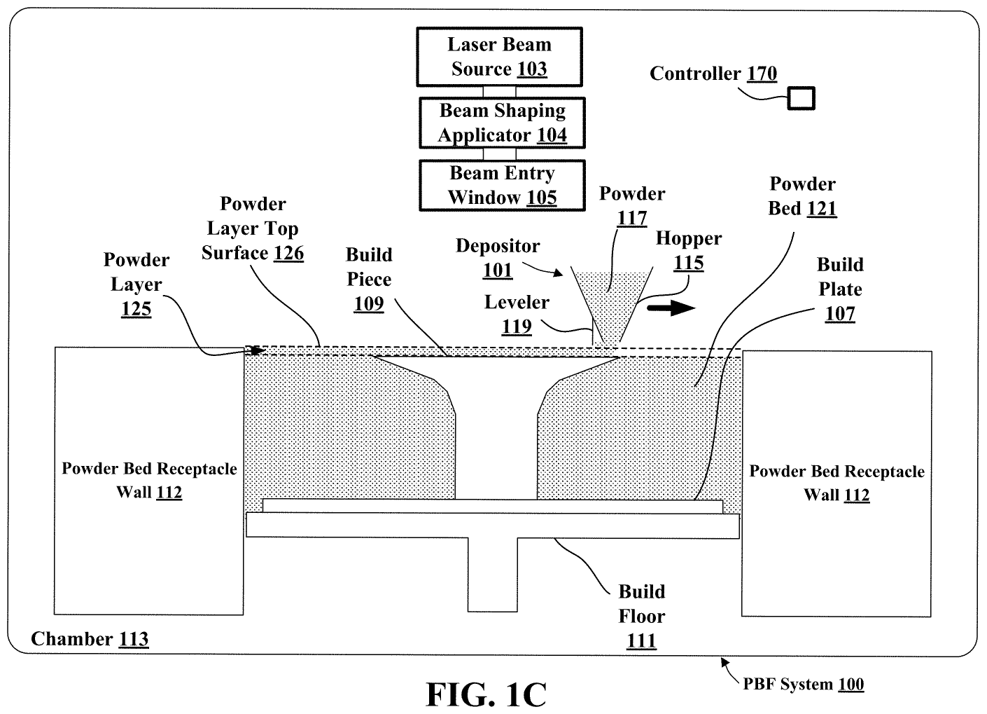

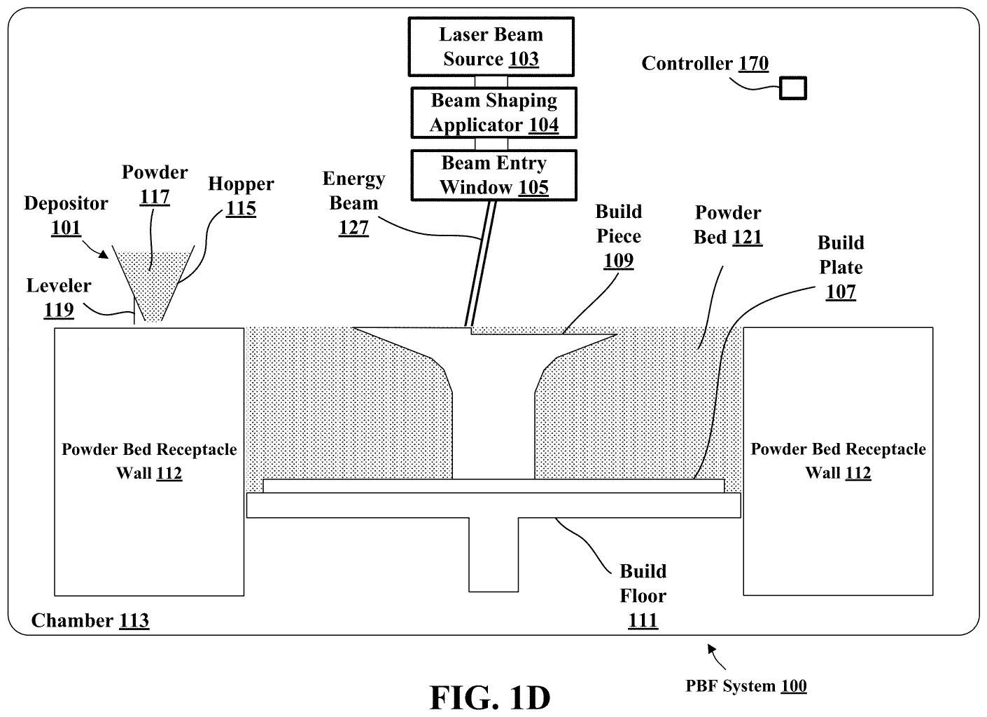

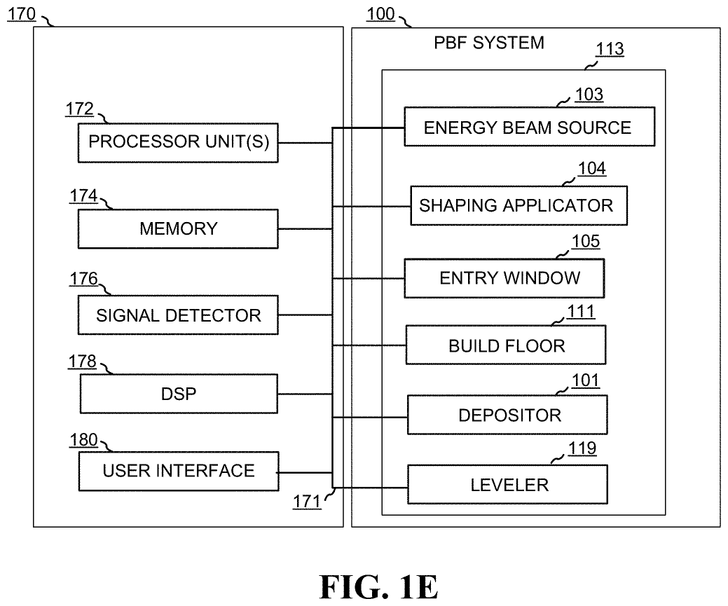

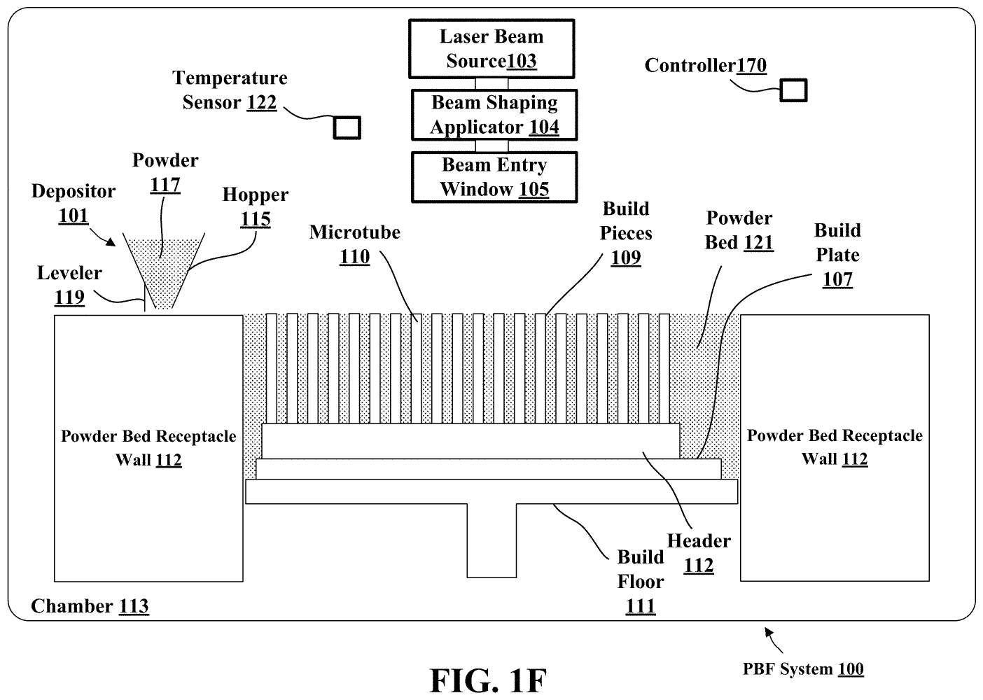

FIGS. 1A-E illustrate respective side views of an exemplary L-PBF system 100 where the example beam structure is a laser beam during different stages of operation. While FIGS. 1A-E relate to examples involving a laser beam, it is understood that different but similar components can be used to implement the same or similar beam-forming techniques in AM systems where the beam is not a laser beam. As noted above, the particular embodiments illustrated in FIGS. 1A-E are one of many suitable examples of an L-PBF system employing the techniques of this disclosure. It should also be noted that elements of FIGS. 1A-E and the other figures in this disclosure are not necessarily drawn to scale, and may be drawn larger or smaller for the purpose of better illustration of concepts described herein. L-PBF system 100 may include a depositor 101 that may deposit each layer of powder material, a laser beam source 103 configured to generate a laser beam, a beam shaping applicator 104 configured to shape the laser beam into one or more geometries, a beam entry window 105 configured to isolate the beam source 103 and the beam shaping applicator 104 from the chamber where fusion of the print material occurs, and a build plate 107 that may support one or more build pieces, such as a build piece 109. In some examples, the beam entry window 105 may include a coating to configured to prevent backscatter of the laser beam back to the laser beam source 103 or the beam shaping applicator 104. As shown, beam shaping applicator 104 is positioned between beam source 103 and beam entry window 105.

While the beam source 103, beam shaping applicator 104, and beam entry window 105 are generally identified and described as separate components, in some exemplary embodiments the functionality of these components may be combined in any fashion, or may be included as part of a single integrated structure, without departing from the scope of the disclosure.

Beam shaping applicator 104 may include a plurality of components. For example, beam shaping applicator 104 may include a fixed optical element and a movable optical element aligned to encompass the beam. One or more optical elements of the beam shaping applicator 104 may include a lens. As another example, beam shaping applicator 104 may include a first axicon lens, a second axicon lens, and a focusing lens. As another example, beam shaping applicator 104 may include a polarizing beam splitter and a detector, where the polarizing beam splitter is configured to split the beam into a first path and a second path. The first path is in the direction of an additional lens, such as a focusing lens. The second path is in the direction of the detector, which may or may not include a lens between the polarizing beam splitter and the detector. The detector may be used to analyze the shape of the beam and provide feedback to the system regarding the same. For example, if the beam is insufficiently shaped in accordance with the desired geometrical shape, the detector may be configured to provide such information to a controller. The controller may be configured to adjust the shape of the beam until the feedback information received from the detector is indicative of the beam being shaped in accordance with the desired geometrical shape. Beam shaping applicator 104 may include a beam expander, a diffractive beam splitter, a diffractive diffuser, a distortion compensator, an F-theta lens, a phase plate, a mirror, or a combination thereof. Beam shaping applicator 104 may include a deflector configured to direct a shaped beam into the chamber where fusion of the print material occurs. In some examples, beam shaping applicator 104 may include one or more of any number of components described herein with respect to beam shaping applicator 104.

L-PBF system 100 may also include a build floor 111 positioned within a powder bed receptacle 112. The walls of the powder bed receptacle 112 may generally define the boundaries of the powder bed receptacle, which is defined between the walls 112 from the side and a portion of the build floor 112 below. The build floor 111 may progressively lower build plate 107 such that depositor 101 may deposit a next layer of powder material. L-PBF system 100 may include a chamber or housing 113 that may enclose the other components of L-PBF system 100 (e.g., laser beam source 103, beam shaping applicator 104 and beam entry window 105), thereby protecting such other components, enabling atmospheric and temperature regulation and mitigating contamination risks. L-PBF system 100 may include a temperature sensor 122 to monitor the atmospheric temperature, the temperature of the powder material 117 and/or components of L-PBF system 100. Depositor 101 may include a hopper 115 that contains a powder 117, such as a metal powder, for example. Depositor 101 may also include a leveler 119 that may level the top of each layer of deposited powder (see e.g., powder layer 125 of FIG. 1C) by displacing deposited powder 117 above a predefined layer height (e.g., corresponding to powder layer thickness 123 of FIG. 1B).

Referring to FIG. 1A, this figure shows L-PBF system 100 after a slice of build piece 109 has been fused, but before the next layer of powder 117 has been deposited. FIG. 1A illustrates a time at which L-PBF system 100 has already deposited and fused slices in multiple layers, e.g., 150 layers, to form the current state of build piece 109, e.g., formed of 150 slices. The multiple layers already deposited have created a powder bed 121, which includes powder that was deposited but not fused.

FIG. 1B shows L-PBF system 100 at a stage in which build floor 111 may lower by a powder layer thickness 123. The lowering of build floor 111 causes build piece 109 and powder bed 121 to drop by powder layer thickness 123, so that the top of the build piece and powder bed are lower than the top of powder bed receptacle wall 112 by an amount equal to the powder layer thickness. In this way, for example, a space with a consistent thickness equal to powder layer thickness 123 can be created over the tops of build piece 109 and powder bed 121.

FIG. 1C shows L-PBF system 100 at a stage in which depositor 101 is positioned to deposit powder 117 in a space created over the top surfaces of build piece 109 and powder bed 121 and bounded by powder bed receptacle walls 112. In this example, depositor 101 progressively moves over the defined space while releasing powder 117 from hopper 115. Leveler 119 can level the released powder to form a powder layer 125 that has a thickness of substantially equal to the powder layer thickness 123 (see FIG. 1B). Thus, the powder 117 in L-PBF system 100 may be supported by a powder material support structure, which may include, for example, a build plate 107, a build floor 111, a build piece 109, walls 112, and the like. It should be noted that the illustrated thickness of powder layer 125 (e.g., powder layer thickness 123 of FIG. 1B) may be greater than an actual thickness used for the example involving 150 previously-deposited layers discussed above with reference to FIG. 1A.

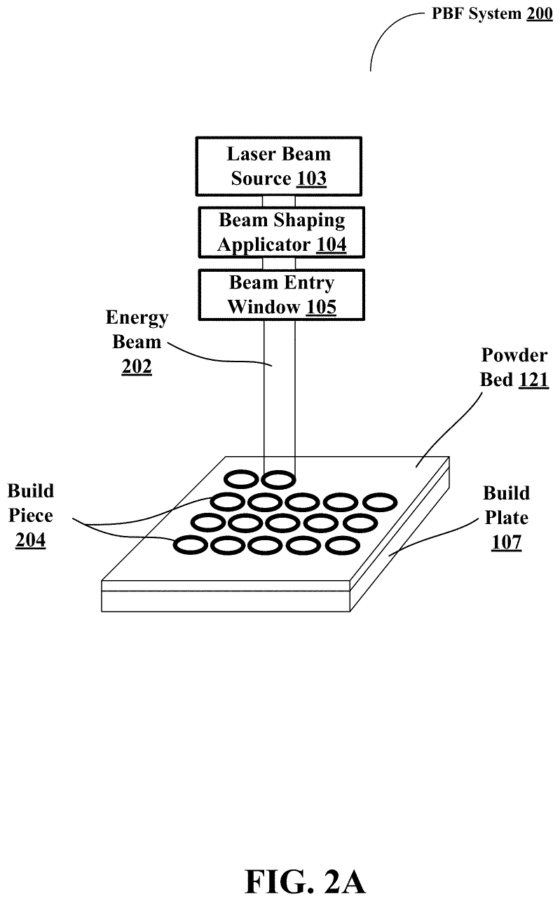

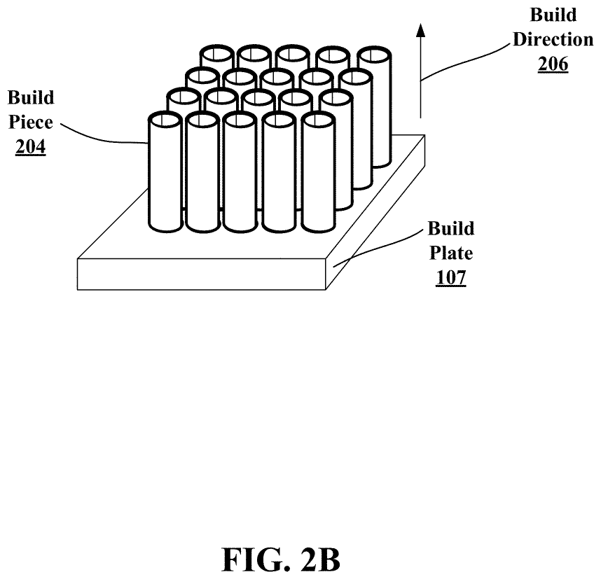

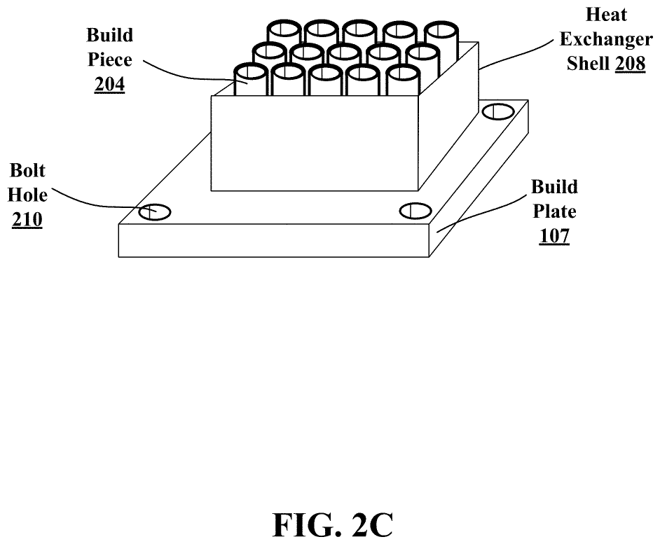

FIG. 1D illustrates the L-PBF system 100 generating a next slice in build piece 109 following the deposition of powder layer 125 (FIG. 1C). Referring to FIG. 1D, laser beam source 103 may generate a laser beam. The beam shaping applicator 104 may be used to vary the geometric shape of the laser beam to be in the form of a line, a square, a rectangle, or other two-dimensional shape. In some examples, beam shaping applicator 104 may shape the laser beam through phase plates and free spacing propagation. The beam shaping applicator 104 may include multiple diffracting, reflecting and refracting apparatus, such as diffractive beam splitters, diffractive diffusers, phase plates, lenses, mirrors or other optical elements. Changes in the size and geometry of the laser beam 127 may, for example, be achieved by motorized displacement of the optical elements of beam shaping applicator 104 as discussed further below with reference to FIGS. 2A-B. In some examples, the geometry of the beam shape may be set according to the build piece 109. The geometry of the beam shape may be modified on a slice-by slice basis based on the geometry of the build piece to reduce scan time for a particular layer. In some examples, the geometry of the beam shape may also be modified mid-layer or even continuously throughout the layer when scanning of the build piece 109.

A deflector in beam shaping applicator 104 may apply laser beam 127 in the selected geometric shape to fuse the next slice in build piece 109. In various embodiments, the deflector may include one or more gimbals and actuators that can rotate and/or translate beam source 103 and/or beam shaping applicator 104 to position beam 127. In various embodiments, beam source 103 and beam shaping applicator 104 can modulate the beam, e.g., turn the beam on and off as the deflector scans such that the beam is applied only in the appropriate areas of the powder layer. For example, in various embodiments, the laser beam can be modulated by a digital signal processor (DSP).

As shown in FIG. 1D, much of the fusing of powder layer 125 occurs in areas of the powder layer that are on top of the previous slice, i.e., previously-fused powder. An example of such an area is the surface of build piece 109. The fusing of the powder layer in FIG. 1D is occurring over the previously fused layers characterizing the substance of build piece 109.

FIG. 1E illustrates a functional block diagram of a 3-D printer system in accordance with an aspect of the present disclosure.

In an aspect of the present disclosure, control devices and/or elements, including computer software, may be coupled to PBF system 100 to control one or more components within PBF system 100. Such a device may be a computer 170, which may include one or more components that may assist in the control of PBF system 100. Computer 170 may communicate with a PBF system 100, and/or other AM systems, via one or more interfaces 171. The computer 170 and/or interface 171 are examples of devices that may be configured to implement the various methods described herein, that may assist in controlling PBF system 100 and/or other AM systems.

In an aspect of the present disclosure, computer 170 (also referred to as controller 170 herein) may comprise at least one processor 172, memory 174, signal detector 176, a digital signal processor (DSP) 178, and one or more user interfaces 180. Computer 170 may include additional components without departing from the scope of the present disclosure.

Processor 172 may assist in the control and/or operation of PBF system 100. The processor 172 may also be referred to as a central processing unit (CPU). Memory 174, which may include both read-only memory (ROM) and random access memory (RAM), may provide instructions and/or data to the processor 172. A portion of the memory 174 may also include non-volatile random access memory (NVRAM). The processor 172 typically performs logical and arithmetic operations based on program instructions stored within the memory 174. The instructions in the memory 174 may be executable (by the processor 172, for example) to implement the methods described herein.

The processor 172 may comprise or be a component of a processing system implemented with one or more processors. The one or more processors may be implemented with any combination of general-purpose microprocessors, microcontrollers, digital signal processors (DSPs), floating point gate arrays (FPGAs), programmable logic devices (PLDs), controllers, state machines, gated logic, discrete hardware components, dedicated hardware finite state machines, or any other suitable entities that can perform calculations or other manipulations of information.

The processor 172 may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, RS-274 instructions (G-code), numerical control (NC) programming language, and/or any other suitable format of code). The instructions, when executed by the one or more processors, cause the processing system to perform the various functions described herein.

Signal detector 176 may be used to detect and quantify any level of signals received by the computer 170 for use by the processor 172 and/or other components of the computer 170. The signal detector 176 may detect such signals as energy beam source 103 power, deflector 105 position, build floor 111 height, amount of powder 117 remaining in depositor 101, leveler 119 position, temperature readings from temperature sensor 122, and other signals. DSP 178 may be used in processing signals received by the computer 170. The DSP 178 may be configured to generate instructions and/or packets of instructions for transmission to PBF system 100.

The user interface 180 may comprise a keypad, a pointing device, and/or a display. The user interface 180 may include any element or component that conveys information to a user of the computer 170 and/or receives input from the user.

The various components of the computer 170 may be coupled together by interface 171, which may include, e.g., a bus system. The interface 171 may include a data bus, for example, as well as a power bus, a control signal bus, and a status signal bus in addition to the data bus. Components of the computer 170 may be coupled together or accept or provide inputs to each other using some other mechanism.

As described in FIGS. 1A-1D, L-PBF system 100 may include a controller 170 that may be configured to cause one or more components of L-PBF system 100 to perform one or more functions. Controller 170 may be configured to receive information relating to the additive manufacturing environment (e.g., where the power bed exists and the build piece(s) is/are created). In some examples, information relating to the additive manufacturing environment may include, for example, a focal location of the shaped beam within the additive manufacturing environment, a distance from the focal location to a second location, and an angle between the focal location and the second location. In some examples, the second location may be a location corresponding to where the shaped beam originates. In some examples, the second location may correspond to where a focusing lens of beam shaping applicator 104 is located. In some examples, the second location may correspond to where the shaped beam enters the additive manufacturing environment.

Controller 170 may be configured to determine a distortion based on the information relating to the additive manufacturing environment, and control the beam shaping applicator to shape the beam into the desired geometry to compensate for the distortion. In some examples, controller 170 may be configured to control beam shaping applicator 104 to shape the beam into the desired geometry to compensate for the distortion by being configured to shape the beam into the desired geometry to compensate for the distortion such that the beam has the desired geometry at a focal location within the additive manufacturing environment, such as a focal location on powder bed 121.

In some examples, controller 170 may be configured to control a power density of the beam emitted from the beam source 103. Controller 170 may be configured to receive feedback information from beam shaping applicator 104. Based on the feedback information, controller 170 may be configured to determine if the beam is sufficiently or insufficiently shaped in accordance with the desired geometrical shape. Controller 170 may be configured to cause one or more components of beam shaping applicator 104 to move, adjust, or otherwise change one or more settings or parameters until the feedback information received from beam shaping applicator 104 (e.g., a detector of the beam shaping applicator 104) is indicative of the beam being shaped in accordance with the desired geometrical shape.

Although a number of separate components are illustrated in FIG. 1E, one or more of the components may be combined or commonly implemented. For example, the processor 172 may be used to implement not only the functionality described herein with respect to the processor 172, but also to implement the functionality described herein with respect to the signal detector 176, the DSP 178, and/or the user interface 180. Further, each of the components illustrated in FIG. 1E may be implemented using a plurality of separate elements.

In some embodiments, the CAD software or applications working in conjunction with the CAD software may determine an optimal sequence of varying shapes as a function of time for use in an additive manufacturing print job. The software may take into account, among other variables, some or all of the factors described above, including temperature profiles, areas where pre-heating and/or pre-cooling are favorable, geometrical shape of the build object, desire to minimize vaporization effects, etc. The beam shaping applicator 104 may be built using various hardware elements referenced herein and implemented in a 3-D printer to adapt the geometrical shape of the beam. The beam shaping applicator 104 may be configured to change the beam shape over time. Moving lenses and other optical elements, in conjunction with fixed elements, may assist in providing the capability to change the beam shape. The CAD software and/or application software associated therewith may be used as a data model for providing instructions to the additive manufacturing printer to operate the beam shaping applicator 104 and the power profile of the beam source 103 in a manner that will render the desired results for a given build piece.

FIG. 1F illustrates a side view of a 3-D printer system in accordance with an aspect of the present disclosure.

FIG. 1F illustrates L-PBF system 100 after multiple slices of build piece 109 have been fused. For example, and not by way of limitation, build piece(s) 109 may include a plurality of microtubes 110 and a header 112 that may function as a heat exchanger.

Lasers in conventional L-PBF systems have accuracies of 0.05 mm in the XY-plane of printing caused by, for example, the movement of the scan heads of the optical apparatus (i.e., the mechanical control of the laser's focal point) and how much material will be melted by the laser focal point on the powder bed 121. Additionally, the tolerance of the L-PBF method is often limited by the accuracy of the generation of straight-line tool paths for the Gaussian beam exiting the beam entry window 105. Such limitations can make accurately printing microtubes difficult. Microtubes have been used to increase the efficiency of heat exchangers by increasing the surface area of the heat exchange. Besides improving the heat transfer coefficient, the application of microtubes in heat exchangers also enables a smaller pressure drop and an increase in the energy efficiency of the heat exchanger.

The techniques disclosed herein enable a more accurate methodology of manufacturing microtubes in addition to other structures. For example, in accordance with the techniques described herein, a shaped beam having a geometry including a two-dimensional shape with a perimeter (e.g., an annular-shaped beam, an oval-shaped beam, etc.) and a hole in the two-dimensional shape within the perimeter can be used to process a contiguous annular area of the powder bed at a time, resulting in, for example, the generation of tubular structures with better accuracy and improved circularity or curvature. Beam shaping applicator 104 may be configured to adjust the radius or diameter of an annular-shaped beam. Beam shaping applicator 104 may also be configured to adjust the curvature of the perimeter of a geometrically-shaped beam in accordance with the techniques described herein.

FIGS. 2A-2C illustrate a printing process in accordance with an aspect of the present disclosure.

PBF System 200 comprises components similar to PBF system 100. For ease of understanding, some of the components of PBF system 200 are not shown in FIGS. 2A-2B.

As shown in FIG. 2A, energy beam 202, which may be a laser beam, is directed toward powder bed 121 on build plate 107 to fuse the powder into build piece 204. In an aspect of the present disclosure, energy beam 202 is an annular energy beam, in that surface where energy beam 202 meets powder bed 121 is circular, oval, or otherwise a rounded shape with a perimeter and a hole in the shape within the perimeter. As described with respect to FIGS. 1A-1D, build piece 204 is printed in a layer-by-layer fashion, such that an annular cross-section of one layer lies substantially on top of an annular cross section in the layer below.

Energy beam 202 can be formed in an annular form by controlling optical elements within beam shaping applicator 104 and applied to the powder bed layer-by-layer to form a plurality of build pieces 204, which in an aspect of the present disclosure may be microtubes.

As shown in FIG. 2B, the build process of FIG. 2A has been continued in build direction 206 in the direction shown in FIG. 2B. After a series of layers have been printed, and once the excess powder is removed from build plate 107, build piece 204 can be a group of tubular structures having circular cross-sections. In an aspect of the present disclosure, the tubular structures shown as build piece 204 can be a group of microtubes, and can be used as part of a heat exchanger.

As shown in FIG. 2C, other parts of a heat exchanger may be printed during printing of the build piece 204. For example, and not by way of limitation, heat exchanger shell 208 and one or more bolt holes 210 may be constructed as part of build piece 204, and may be built as part of build plate 107 as desired.

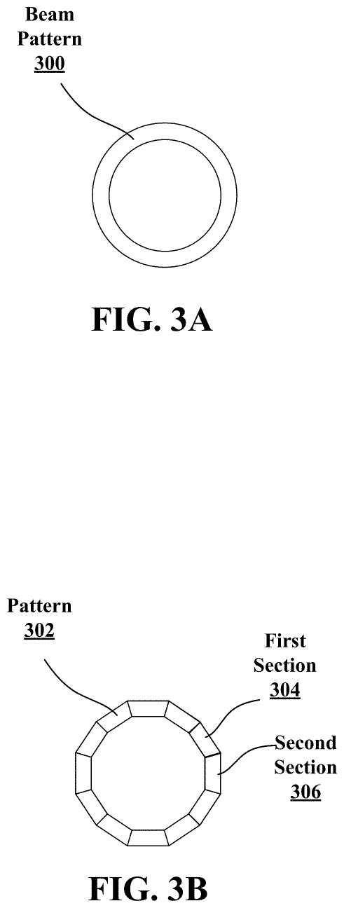

FIG. 3A illustrates a cross-sectional view of an additively-manufactured microtube in accordance with an aspect of the present disclosure.

As discussed with respect to FIGS. 2A-2C, in an aspect of the present disclosure, beam shaping applicator 104 may produce an energy beam 204 having a beam pattern 300 that is substantially annular. Depending on the orientation of the optical elements in beam shaping applicator 104, beam pattern 300 may be circular, oval, or other rounded shapes, such that the focal plane of beam pattern 300 can take any desired shape at the point where energy beam 204 meets the surface of powder bed 121.

By using an energy beam 202 having an annular shape, i.e., beam pattern 300, to produce microtubes, an aspect of the present disclosure may allow for higher accuracy, better circularity of the microtubes, and/or smaller dimensions of each of the microtubes. In an aspect of the present disclosure, the annular beam pattern 300 is able to melt a ring of material together at the same time.

In an aspect of the present disclosure, a beam shaping applicator may be configured to produce and/or shape the energy beam into a given geometry, i.e., beam pattern 300, as shown in FIG. 3A. Such a beam pattern 300 may have an annular region which contains enough energy to sinter and/or fuse the powder in the powder bed for a given layer in the annular region, while lacking enough energy to fuse and/or sinter the powder inside of the annular region, i.e., in the hole. In other words, such a beam pattern may have a curved or substantially curved perimeter which contains the requisite energy to fuse the powder and a hole, cavity, or void area internal to the perimeter region that does not contain the requisite energy to fuse the powder within that region. The beam pattern 300 may be a two dimensional shape as shown in FIG. 3A, or other two dimensional shapes as desired, without departing from the scope of the present disclosure. A shape of the hole may be a circle, an ellipse, or an oval, and the two-dimensional shape of the beam pattern may be a circle, an ellipse, or an oval.

FIG. 3B illustrates a cross-sectional view of an additively-manufactured microtube in accordance with the related art.

As shown in FIG. 3B, pattern 302 is piecewise linear. Further, pattern 302, in a conventional L-PBF process, is printed in sections, e.g., first section 304, second section 306, etc. to create pattern 304, as opposed to pattern 300 in FIG. 3A which may be printed all at the same time, i.e., with a single “flash” of the laser. In the conventional L-PBF process, these successive number of short vectors, i.e., first section 304, second section 306, etc., to construct a piecewise linear pattern 302, may introduce inconsistencies in the build process. For example, and not by way of limitation, printing pattern 302 may take more time due to the activation and deactivation of the laser and may result in inaccurate shape of the microtubes, i.e., polygonal, not truly circular. Additionally, the minimum length of each section (e.g., first section 304) for a conventionally generated polygonal ring limits the minimum achievable diameter of the microtubes.

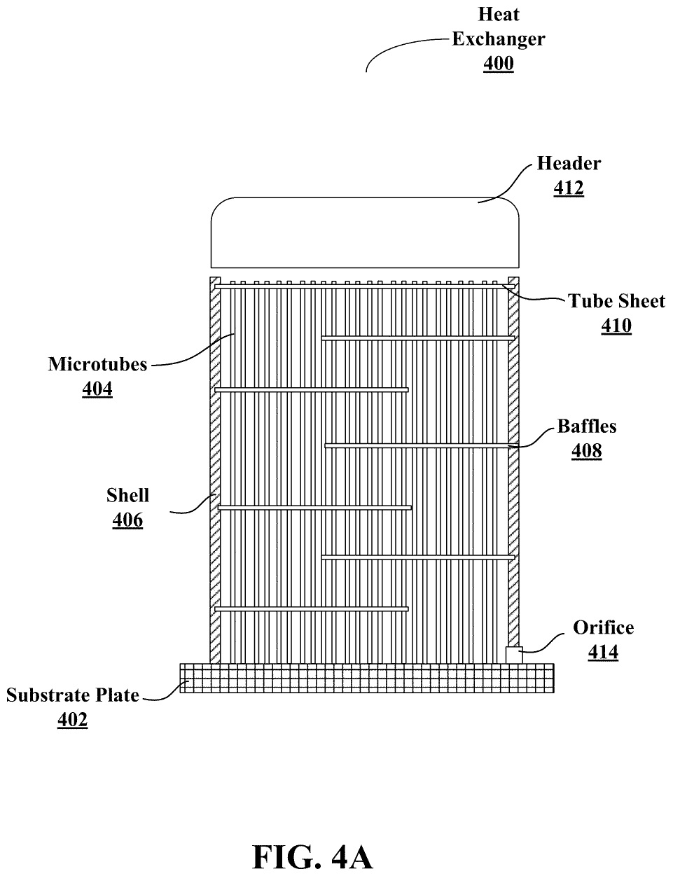

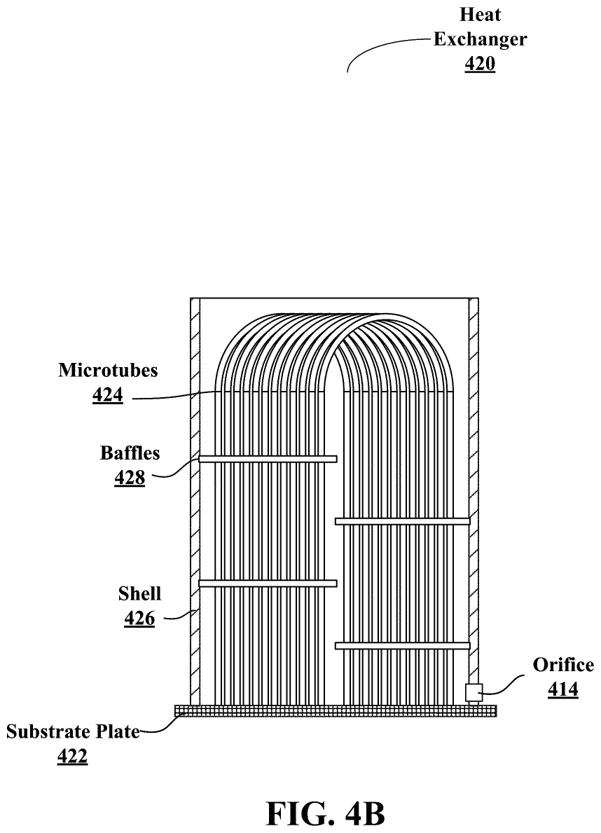

FIG. 4A illustrates a straight-tube microtube heat exchanger in accordance with an aspect of the present disclosure.

Heat exchanger 400 may comprise, inter alia, a substrate plate 402, one or more microtubes 404, a shell 406, one or more baffles 408, a tube sheet 410, and a header 412. Each of the components of heat exchanger 400 may be additively manufactured, or, if desired, some of the components, e.g., header 412, shell 406, etc., may be conventionally manufactured.

As shown in FIG. 4A, microtubes 404 are coupled to substrate plate 402, and the fluid flow between the substrate plate 402 and header 412 may include baffles 408. Tube sheet 410 may be included, and header 412 may be coupled to shell 406 as a separate component.

FIG. 4B illustrates a curved-tube microtube heat exchanger in accordance with an aspect of the present disclosure.

As shown in FIG. 4B, heat exchanger 420 may comprise, inter alia, a substrate plate 422, one or more microtubes 424, a shell 426, and one or more baffles 428. In heat exchanger 420, however, portions of microtubes 424 are printed using annular beam geometries other than circular, e.g., oval, etc., to allow for connection of one microtube 424 with another printed microtube 424 to create a “U” shaped microtube.

The geometry of the energy beam 202 may be adjusted by beam shaping applicator 104 to change the eccentricity of the beam as the verticality (i.e., increase in the build direction 206 value as the number of build layers increases).

With respect to both FIGS. 4A and 4B, microtubes 404/424 may be printed directly onto a substrate plate 402/422 that is part of a tube-and-shell heat exchanger. The substrate plate 402/422 may be perforated before or after the additive manufacturing process. Energy beam 202 may be focused into a single spot, rather than an annular beam pattern 300, for manufacturing of shell 406/426, and shell 406/402 may take any geometrical shape, e.g., round, rectangular, trapezoidal, etc., as desired.

Further, one or more orifices 414 may be printed in the shell 406/426 to function as powder egress holes, as inlets/outlets for shell 406/426 fluids, or for other reasons. In an aspect of the present disclosure, baffles 408/428, other fitting features, and additional features such as fins and bends can be printed on the shells 406/426 and/or on the baffles 408/428 to control the flow of the fluids and improve the efficiency of the heat exchanger 400/420.

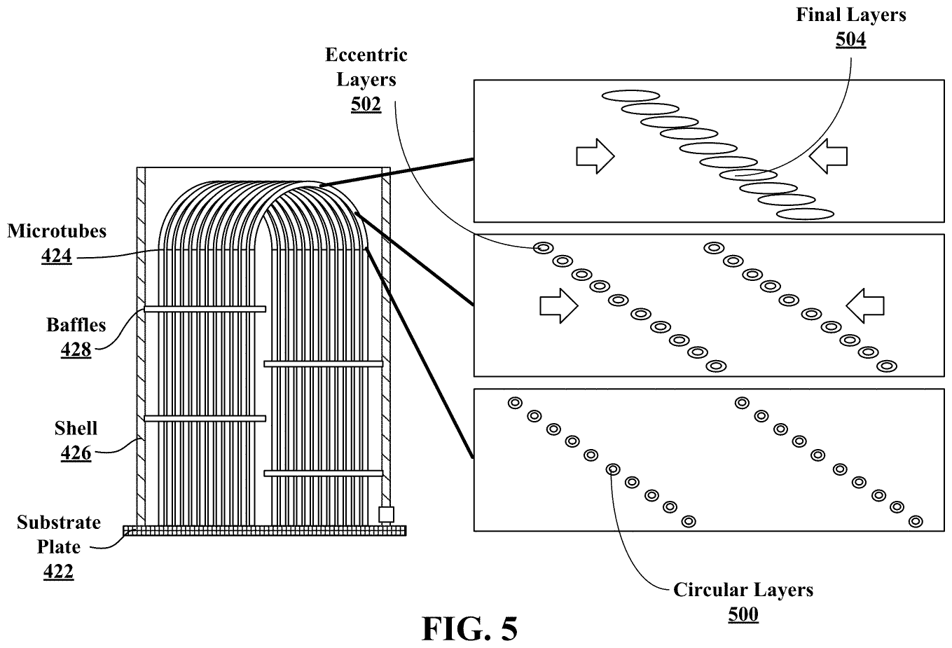

FIG. 5 illustrates a geometrical change in beam pattern in accordance with an aspect of the present disclosure.

As U-shaped microtubes 424 shown in FIG. 4B are printed, in an aspect of the present disclosure, the annular beam shape may be changed to create the curved portion of the U-shaped microtubes 424. Further, the beam pattern may also be changed to print baffles 428, shell 426, and/or other features of a given component as desired without departing from the scope of the present disclosure.

The initial, vertical sections of microtubes 424 are circular in cross section with respect to the powder layer in which they are printed, and, as such, circular layers are printed. Circular layers 500 are shown as indicating the layer cross section, and also define the beam pattern (e.g., beam pattern 300) to be used to print those layers of the overall component.

As the print progresses, the desired shapes of the microtubes 424 begin to curve toward each other in each successive layer. Thus, the beam pattern, shown as eccentric layers 502, becomes more eccentric (i.e., more oval in shape) for those layers, and two sets of oval patterns are shown as the microtubes 424 are not yet connected together.

As the tops of the “U” shape of the microtubes 424 are to be printed, only a single, eccentric beam pattern is used to connect the two microtube structures together. Final layers 504 are shown as a single oval per “connected” microtube structure, as the fused powder will couple the vertical and curved sections together at the top of the printed structure.

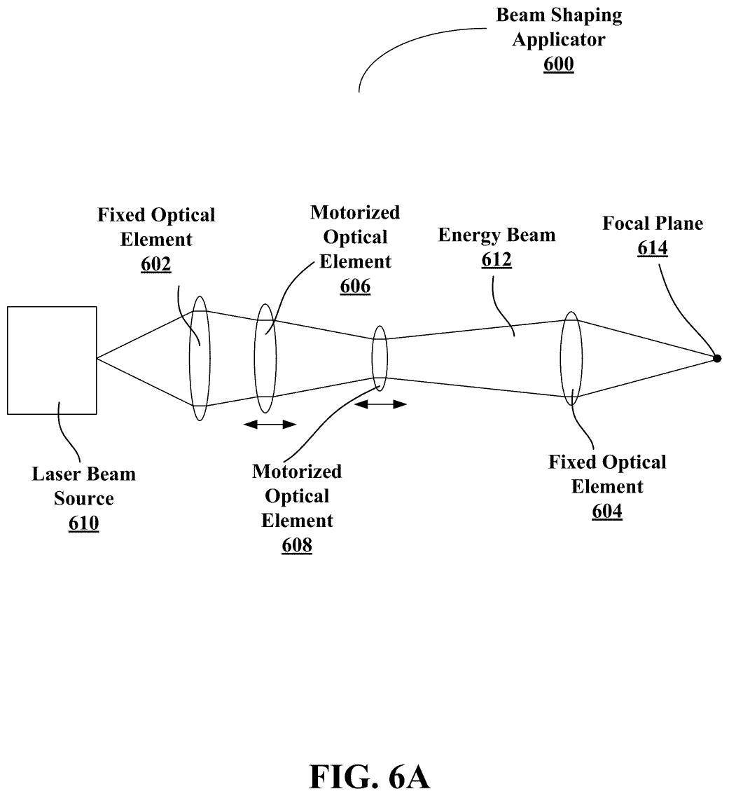

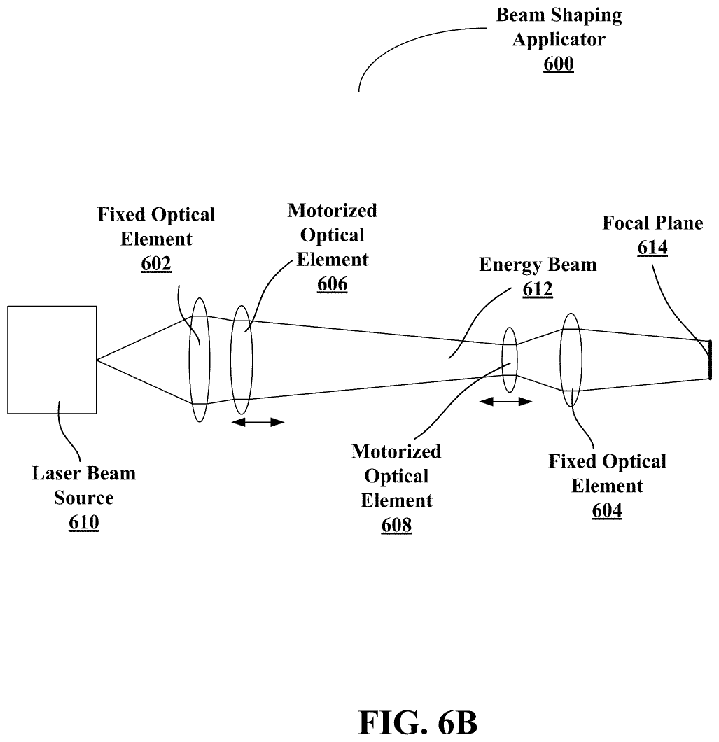

FIGS. 6A and 6B illustrate beam shaping applicators in accordance with an aspect of the present disclosure.

As shown in FIG. 6A, beam shaping applicator 600, which may be employed in an aspect of the present disclosure as beam shaping applicator 104, may include, inter alia, fixed optical elements 602 and 604, and one or more motorized optical elements 606 and 608. The fixed optical elements 602 and 604 may have a fixed position such that optical elements are not typically displaced or moved with respect to laser beam source 610 or other reference points within PBF system 200. Motorized optical elements 606 and 608 may each include one or more optical elements (e.g., a lens) with a motor component (not shown) to adjust the position of the optical element of the motorized optical element 606 and/or 608 as a function of time or to change the focus/focal plane presentation of energy beam 612.

FIG. 6A illustrates that the fixed optical elements 602 and 604, and the motorized optical elements 606 and 608, when placed in a desired configuration present energy beam 612 at focal plane 614 at a certain geometry. As shown in FIG. 6A, the focal plane 614 geometry is a point, which may have a desired diameter. In a PBF system 200 of the present disclosure, focal plane 614 may be at the surface of the powder bed, i.e., powder layer top surface 126, as shown in FIG. 1C.

FIG. 6B illustrates beam shaping applicator 600 at a different point in time, where motorized optical elements have been moved with respect to laser beam source 610 and/or fixed optical elements 602 and 604, such that the geometry of energy beam 612 at focal plane 614 is different than in FIG. 6A. For example, and not by way of limitation, the geometry of energy beam 612 in FIG. 6B may be an annular shape, a line, a rectangle, or any desired shape that can be generated by beam shaping applicator 600.

Although the exemplary beam shaping applicator 600 shown in FIGS. 6A and 6B includes two motorized optical elements 606 and 608, and two fixed optical elements 602 and 604, any number of optical elements may be used to generate a desired energy beam 612 geometry at focal plane 614. Further, although shown as lenses in FIGS. 6A and 6B, the optical elements 602-608 may be of any form, e.g., phase plates, gratings, reticons, convex and/or concave lenses, axicons, diffractive diffusers, beam splitters, mirrors, etc., without departing from the scope of the present disclosure. Further, other mechanisms may be used to shape the energy beam 612 to achieve a desired beam geometry at focal plane 614 without departing from the scope of the present disclosure. For example, and not by way of limitation, the beam shaping applicator 600 may include a deflector configured to control a direction at which the shaped energy beam 612 is applied to the additive manufacturing material, e.g., powder, at focal plane 614.

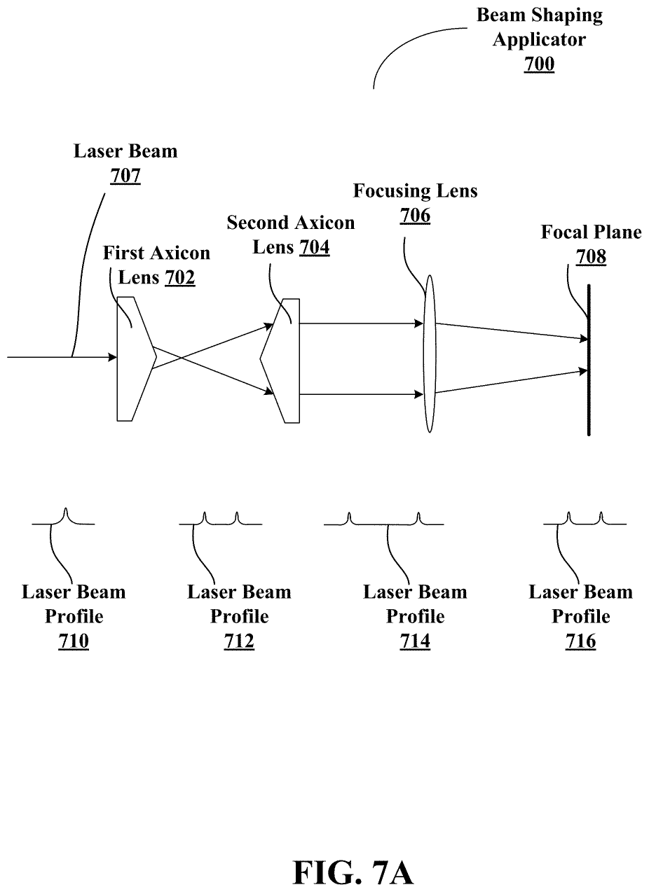

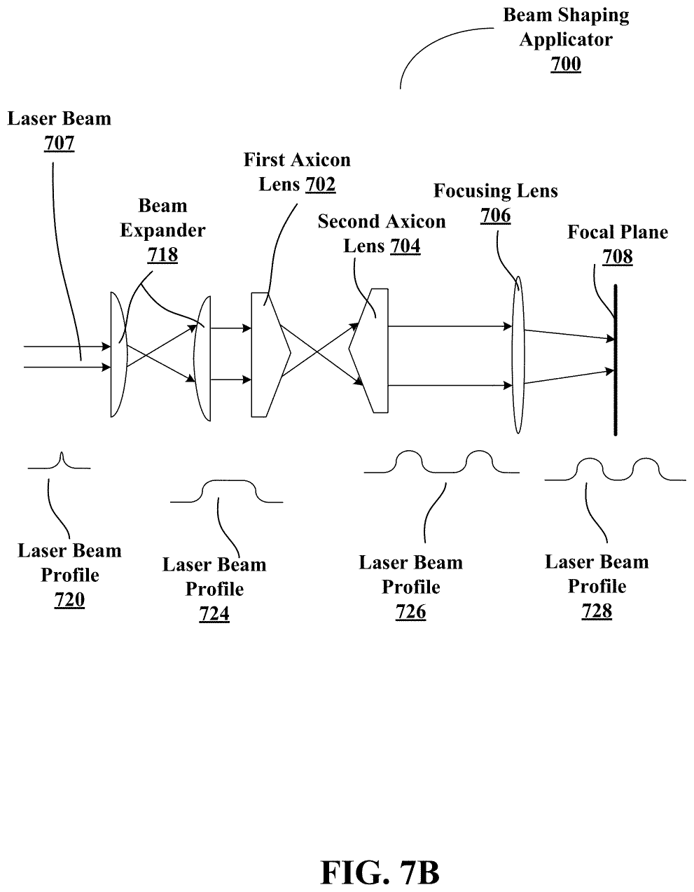

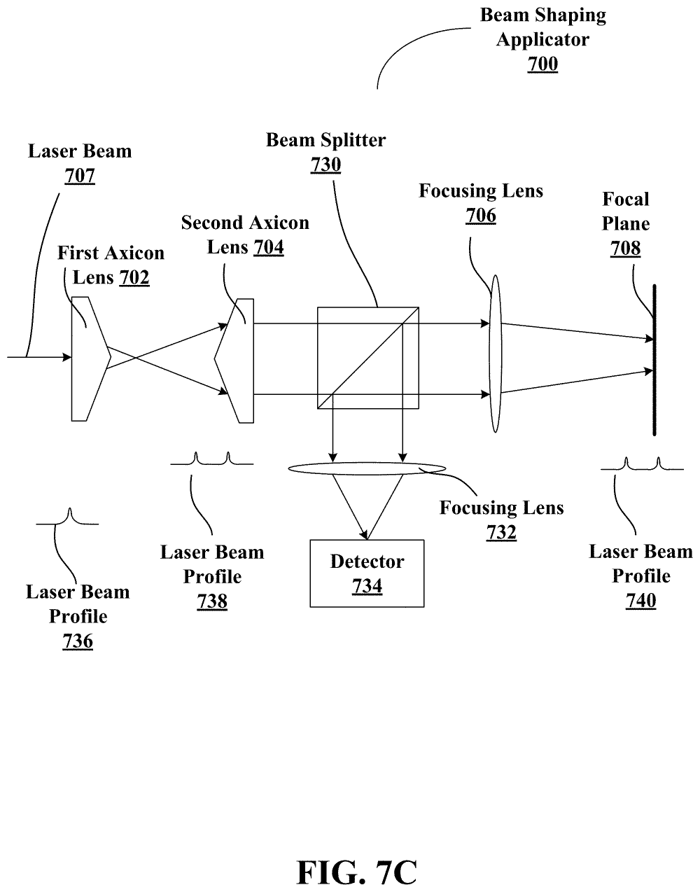

FIGS. 7A-7C illustrate a beam shaping applicator in different configurations in accordance with various aspects of the present disclosure.

As shown in FIG. 7A, beam shaping applicator 700 may comprise, inter alia, a first axicon lens 702, a second axicon lens 704, and a focusing lens 706. First axicon lens 702, second axicon lens 704, and focusing lens 706 may be positioned in various locations to focus laser beam 707 at desired geometries on focal plane 708. Focal plane 708 may be powder layer top surface 126, or other locations within PBF system 200 as desired.

Also shown in FIG. 7A are various laser beam profiles 710-726. Prior to laser beam 707 interacting with first axicon lens 702, laser beam 707 has a profile of a single energy spike. Once laser beam 707 passes through first axicon lens 702 the energy profile of laser beam 707 has two energy spikes as shown in laser beam profile 712. After passing through second axicon lens 704, laser beam 707 still has two energy spikes as shown in laser beam profile 714, but the spikes are slightly further apart. After passing through focusing lens 706, laser beam 707 still has two energy spikes as shown in laser beam profile 716, but the spikes have become closer together due to focusing lens 706; however, moving focusing lens 706 may focus the laser beam 707 down to a single point, i.e., a single spike in its profile, on focal plane 708 if desired.

As shown in FIG. 7B, beam shaping applicator 700 may further include beam expander 718, which expands laser beam 707 to have a wider beam pattern. As in FIG. 7A, laser beam 707 initially has a laser beam profile 720 having a single energy spike. This single energy spike is maintained through beam expander 718 as shown by 1 laser beam profile 724, but the width of the spike has been increased. Once laser beam 707 passes through first axicon lens 702 and second axicon lens 706, two energy spikes are present, as shown by laser beam profile 726. Note, the width of each spike in profile 726 is wider than the width of each spike in profile 714 in the example in FIG. 7A. Focusing lens 706 can maintain this double energy spike profile while reducing the distance between the spikes at focal plane 708 as shown by laser beam profile 728.

FIG. 7C illustrates the beam shaping applicator 700 of FIG. 7A, further including a beam splitter 730, optional focusing lens 732, and detector 734. Inclusion of a beam splitter 730, which may be a polarizing beam splitter, allows for monitoring of laser beam 707. Detector 734 and optional focusing lens 732 also may allow for monitoring of the geometry of the laser beam 707 at focal plane 708 or other locations in beam shaping applicator 700.

Laser beam 707 initially has a single energy spike as shown in laser beam profile 736. Once laser beam 707 passes through first axicon lens 702 the energy profile of laser beam 707 has two energy spikes as shown in laser beam profile 738. After passing through focusing lens 706, laser beam 707 is shown as having two energy spikes as shown in laser beam profile 740; however, moving focusing lens 706 may focus the laser beam 707 down to a single point on focal plane 708 if desired. Further, moving focusing lens 732 may change the laser beam energy profile that is impinging upon detector 734.

In an aspect of the present disclosure, controller 170 may be configured to control the movement and/or position of the optical elements within beam shaping applicator 700. Although some examples of beam shaping applicators are described herein, it is understood that these examples and other examples may include one or more diffracting, reflecting, and refracting apparatuses, such as one or more diffractive beam splitters, one or more diffractive diffusers, one or more phase plates, one or more lenses, and one or more mirrors without departing from the scope of the present disclosure.

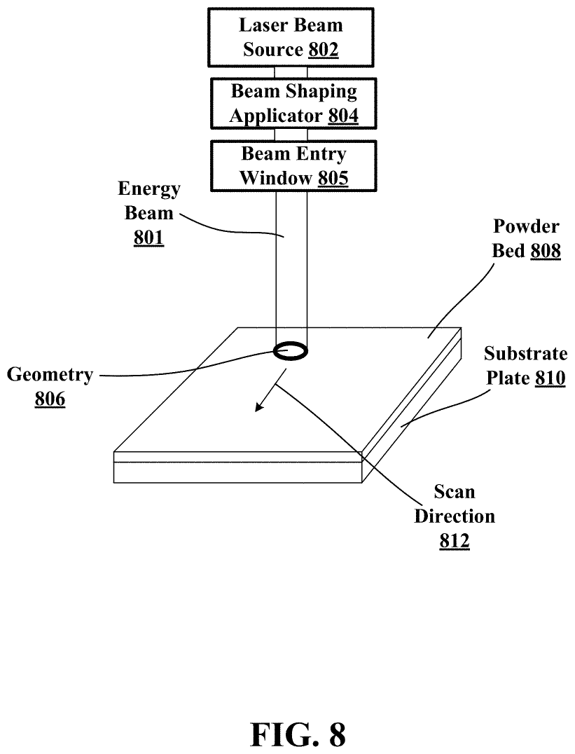

FIG. 8 is a diagram illustrating an exemplary L-PBF system for scanning a build piece in accordance with an aspect of the present disclosure.

Referring to FIG. 8, a laser beam source 802 may supply a laser beam to a beam shaping applicator 804. In this example, beam shaping applicator 804 may be configured similarly to beam shaping applicator 700 (FIGS. 7A-7C). However, other mechanisms may additionally or alternatively be used to adapt the geometrical shape of the laser beam. The beam shaping applicator 804 may modify the laser beam 801 supplied by laser beam source 802 to generate an energy beam spot in the desired geometry 806. The laser beam having the desired geometry 806 may be applied to a powder bed 808 supported by a substrate plate 810. Energy beam 810 may be scanned in scan direction 812.

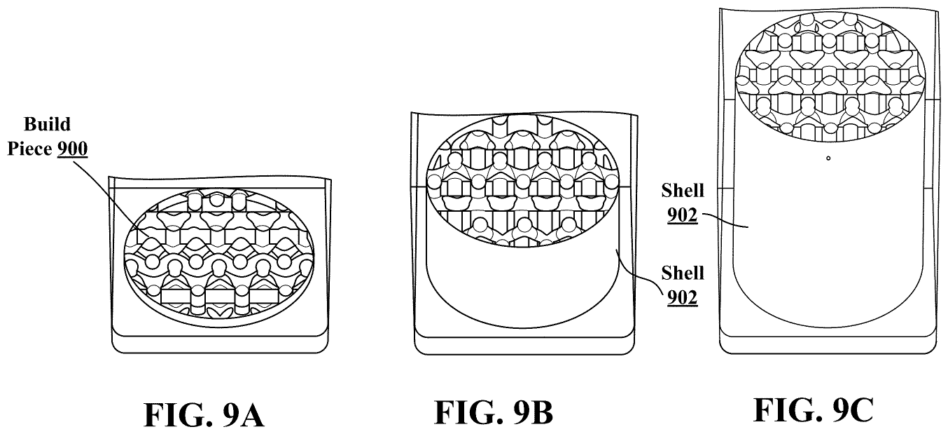

FIGS. 9A-9C illustrate an additively-manufactured geometry in accordance with an aspect of the present disclosure.

As shown in FIGS. 9A-9C, build piece 900 and shell 902 can take various forms, e.g., a circular shell, a wavy form, different shapes of microtubes, etc. FIGS. 9A-9C illustrate the flexibility offered by the techniques described in various aspects of the present disclosure, which may enable the additive manufacturing of non-uniform geometries, substantially circular geometries, etc., that would otherwise be unattainable by conventional manufacturing methods. Aspects of the present disclosure may enable heat transfer intensification features and improve tube density. Additionally, the present disclosure may enable bio-mimicry tube design, which may enables the additive manufacturing of biomedical components, such as an additively manufactured artificial lung. In other examples, the techniques described herein enable a bio-mimicry tube design inspired by human lungs to be additively manufactured in a shell for a heat exchanger.

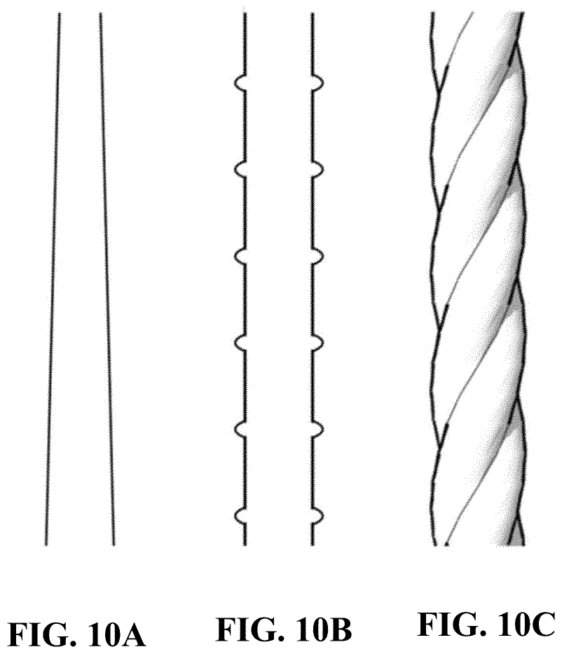

FIGS. 10A-10C illustrate cross-sectional views of geometries of microtube profiles in accordance with various aspects of the present disclosure. In an aspect of the present disclosure, the beam geometry can be adjusted during the additive manufacturing of a given component to manufacture various geometries.

FIG. 10A illustrates an example of a tapered microtube that may be printed in accordance with a dynamically adjusted beam geometry in accordance with an aspect of the present disclosure. In this example, the size of the beam geometry may be decreased gradually over multiple layers during printing, resulting in a gradually tapering microtube. FIG. 10B illustrates an example of a corrugated tube that may be printed in accordance with a dynamically adjusted beam geometry in accordance with an aspect of the present disclosure. In this example, the size of the beam geometry may be kept constant to produce the primary profile of the microtube, and the beam geometry may be increased at regular intervals to produce the “bumps” in the corrugation. FIG. 10C illustrates an example of a spiraled tube that may be printed in accordance with a dynamically adjusted beam geometry in accordance with an aspect of the present disclosure. In this example, the beam geometry may be an oval or elliptical shape that is rotated through multiple layers of printing to produce a spiral shaped microtube.

The previous description is provided to enable any person skilled in the art to practice the various aspects described herein. Various modifications to these exemplary embodiments presented throughout this disclosure will be readily apparent to those skilled in the art, and the concepts disclosed herein may be applied to other support structures and systems and methods for removal of support structures. Thus, the claims are not intended to be limited to the exemplary embodiments presented throughout the disclosure, but are to be accorded the full scope consistent with the language claims. All structural and functional equivalents to the elements of the exemplary embodiments described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f), or analogous law in applicable jurisdictions, unless the element is expressly recited using the phrase “means for” or, in the case of a method claim, the element is recited using the phrase “step for.”

What is claimed is:

1. An apparatus for additive manufacturing, comprising:
an energy beam source configured to generate an energy beam; and
a beam shaping applicator configured to shape the energy beam into a geometry and apply the shaped energy beam to an additive manufacturing material, wherein the geometry includes a two-dimensional shape with a perimeter and a hole in the two-dimensional shape within the perimeter.

2. The apparatus of claim 1, wherein the energy beam is a laser beam.

3. The apparatus of claim 2, wherein the beam shaping applicator comprises a fixed optical element and a movable optical element aligned to encompass the energy beam.

4. The apparatus of claim 3, wherein at least one of the optical elements comprises a lens.

5. The apparatus of claim 2, wherein the beam shaping applicator comprises a first axicon lens, a second axicon lens, and a focusing lens.

6. The apparatus of claim 5, wherein the beam shaping applicator further comprises a polarizing beam splitter and a detector.

7. The apparatus of claim 5, wherein the beam shaping applicator further comprises at least a beam expander, a diffractive beam splitter, a diffractive diffuser, a distortion compensator, an F-theta lens, a phase plate, or a mirror.

8. The apparatus of claim 1, wherein the additive manufacturing material includes a powder material.

9. The apparatus of claim 1, wherein the shape of the geometry is different than a shape of the hole.

10. The apparatus of claim 1, wherein a shape of the hole is a circle, ellipse, or oval.

11. The apparatus of claim 1, wherein the two-dimensional shape is a circle, ellipse, or oval.

12. The apparatus of claim 1, wherein the beam shaping applicator includes a deflector configured to control a direction at which the shaped energy beam is applied to the additive manufacturing material.

13. The apparatus of claim 1, wherein the additive manufacturing material is arranged in an additive manufacturing environment, and the beam shaping applicator is configured to shape the energy beam into the geometry based on information relating to the additive manufacturing environment.

14. The apparatus of claim 13, wherein the information relating to the additive manufacturing environment includes: a focal location of the shaped energy beam within the additive manufacturing environment, a distance from the focal location to a second location, and an angle between the focal location and the second location.

15. The apparatus of claim 14, wherein the second location is a location corresponding to where the shaped energy beam originates.

16. The apparatus of claim 14, wherein the second location corresponds to where a focusing lens of the beam shaping applicator is located.

17. The apparatus of claim 14, wherein the second location corresponds to where the shaped beam enters the additive manufacturing environment.

18. The apparatus of claim 13, further comprising a controller configured to:
determine, based on the information relating to the additive manufacturing environment, a distortion; and
control the beam shaping applicator to shape the energy beam into the geometry to compensate for the distortion.

19. The apparatus of claim 18, wherein the controller is configured to control the beam shaping applicator to shape the energy beam into the geometry to compensate for the distortion by being configured to shape the energy beam into the geometry to compensate for the distortion such that the energy beam has the geometry at a focal location within the additive manufacturing environment.

20. The apparatus of claim 1, further comprising:
a controller configured to control a power density of the energy beam emitted from the energy beam source.
